(19) United States
(12) Patent Application Publication
(10) Pub. No.: US 2026/0299272 A1
(43) Pub. Date: Oct. 1, 2026

(54) Chromatic Confocal System for Line-Scanning an Object

(71) Applicant: Hong Kong Applied Science And Technology Research Institute Co., Ltd., Shatin (HK)

(72) Inventors: Sifan Xie, Shatin (HK); Yong Chi, Fanling (HK); Jinbo Jiang, Ocean View (HK); Xueyan Tang, Wu Kai Sha (HK)

(21) Appl. No.: 19/096,181

(22) Filed: Mar. 31, 2025

(51) Int. Cl. G02B 21/00; H04N 13/207; H04N 23/45; H04N 23/55; H04N 23/56; H04N 23/90

(52) U.S. Cl. CPC G02B 21/0052; G02B 21/0032; G02B 21/0036; H04N 13/207; H04N 23/45; H04N 23/55; H04N 23/56; H04N 23/90

(57) ABSTRACT

A chromatic confocal system for line-scanning an object. The system comprises a light module for providing a line-scanning light beam and a chromatic confocal lens module defining a first light pathway for directing the line-scanning light beam along said first light pathway and focusing the line-scanning light beam to impinge on a surface of the object. The lens module also defines a second light pathway for directing line-scanned light reflected from the surface of the object to one or more imaging modules. The line-scanning light beam has a predefined, limited range of wavelengths within the visible light spectrum.

### FIELD OF THE INVENTION

The invention relates to a chromatic confocal system for line-scanning an object. The invention relates particularly, but not exclusively, to a line-scanning 2D/3D imaging sensing system.

### BACKGROUND OF THE INVENTION

A line scanning sensing system is a known technology used for capturing images or data of a scanned object by scanning a single line at a time, rather than capturing an entire image of an object simultaneously. This technique is employed in both 2D and 3D sensing applications.

Line-scanning in 3D sensing systems typically uses a dispersion optical module to split the uniform white light into a continuous spectral line pattern at different heights. The spectrum of different heights reflected by the object surface, after been separated by a suitable grating, then focus on an image sensor to form an object profile image.

Most line scanning systems are designed to handle either 2D or 3D imaging primarily due to several technical and practical considerations such as sensor design, data processing, application requirements, cost and complexity, and performance optimization.

It is desirable to develop a line-scanning imaging system capable of both 2D and 3D sensing, which addresses image shadow issues, simplifies image alignment, measures deep holes and troughs effectively, and provides simultaneous 2D and 3D imaging capabilities.

Therefore, there is a need, among other things, to implement a novel chromatic confocal system for line-scanning an object.

### OBJECTS OF THE INVENTION

An object of the invention is to mitigate or obviate to some degree one or more problems associated with chromatic confocal systems for line-scanning objects.

The above object is met by the combination of features of the main claims; the sub-claims disclose further advantageous embodiments of the invention.

Another object of the invention is to provide a novel chromatic confocal system for line-scanning an object.

A further object of the invention is to provide a method or an algorithm for generating a 2D or 3D image from image data received from an image sensor of the novel chromatic confocal system.

A yet further object of the invention is to provide a line-scanning imaging system capable of simultaneous 2D and 3D sensing.

One skilled in the art will derive from the following description other objects of the invention. Therefore, the foregoing statements of object are not exhaustive and serve merely to illustrate some of the many objects of the present invention.

### SUMMARY OF THE INVENTION

In a first main aspect, the invention provides a chromatic confocal system for line-scanning an object. The system comprises a light module for providing a line-scanning light beam and a chromatic confocal lens module defining a first light pathway for directing the line-scanning light beam along said first light pathway and focusing the line-scanning light beam to impinge on a surface of the object. The lens module also defines a second light pathway for directing line-scanned light reflected from the surface of the object to one or more imaging modules. The line-scanning light beam has a predefined, limited range of wavelengths within the visible light spectrum.

Preferably, the predefined, limited range of wavelengths comprises blue and green light wavelengths within the visible light spectrum.

Preferably, the predefined, limited range of wavelengths comprises wavelengths in a range of 400 nm to 550 nm. Ine some embodiments, the predefined, limited range of wavelengths comprises wavelengths in a range of 450 nm to 550 nm.

Preferably, a numerical aperture of the first light pathway of the chromatic confocal lens module is configured such that the line-scanning light beam has a spot size diffraction limitation of about 0.5 μm, or less than or equal to 0.5 μm.

In a second main aspect, the invention provides a chromatic confocal lens module for a line-scanning system, comprising: an input for receiving a line-scanning light beam from a light source; a first light pathway for directing the line-scanning light beam along said first light pathway and focusing the line-scanning light beam to impinge on a surface of an object; a second light pathway for directing line-scanned light reflected from the surface of the object to an output; wherein the line-scanning light beam has a predefined, limited range of wavelengths.

In a third main aspect, the invention provides a method of generating a 2D or 3D image from image data received from an image sensor of the chromatic confocal system of the first main aspect, the method comprising: receiving Red-Green-Blue (RGB) image data from the image sensor; transforming the RGB image data to Hue-Saturation-Intensity (HSI) values; separating the H values from the HSI values; and using the separated H values to determine hue-to-displacement relationship values based on a plane mirror or plane gauge calibration model of the chromatic confocal system.

In a fourth main aspect, the invention provides a non-transitory computer-readable medium storing machine-readable instructions, wherein, when the machine-readable instructions are executed by a processor, they configure the processor to implement the method of the third main aspect of the invention.

The summary of the invention does not necessarily disclose all the features essential for defining the invention; the invention may reside in a sub-combination of the disclosed features.

The foregoing has outlined fairly broadly the features of the present invention in order that the detailed description of the invention which follows may be better understood. Additional features and advantages of the invention will be described hereinafter which form the subject of the claims of the invention. It will be appreciated by those skilled in the art that the conception and specific embodiment disclosed may be readily utilized as a basis for modifying or designing other structures for carrying out the same purposes of the invention.

### BRIEF DESCRIPTION OF THE DRAWINGS

The foregoing and further features of the present invention will be apparent from the following description of preferred embodiments which are provided by way of example only in connection with the accompanying figures, of which:

FIG. 1 is an isotropic view of a chromatic confocal system for line-scanning an object in accordance with an embodiment of the invention;

FIG. 2 is a side sectional view of the chromatic confocal system of FIG. 1;

FIG. 3 is a graph showing intensity of different light wavelengths to their respective diffraction angles;

FIG. 4 is an exploded view of main parts of a light module for the chromatic confocal system of FIG. 1;

FIG. 5 is a plan view of a LED chip array (not to scale) for the light module of FIG. 4;

FIG. 6 shows an optical simulation result of the light module of FIG. 4;

FIG. 7 is a schematic side sectional view of a 3D imaging module for the chromatic confocal system of FIG. 1;

FIG. 8 shows the light intensities detected at different depths by an image sensor of the imaging module of FIG. 7;

FIG. 9 shows the width-wise profile of each of the light intensities detected at different depths by the image sensor of the imaging module of FIG. 7;

FIG. 10 shows the light colours detected at different depths by the image sensor of the imaging module of FIG. 7;

FIG. 11 illustrates line scanning a stepped object using the chromatic confocal system of FIG. 1;

FIG. 12 shows the 2D image spectrum color distribution of the stepped object using the chromatic confocal system of FIG. 1;

FIG. 13 shows the 2D image intensity distribution of the stepped object using the chromatic confocal system of FIG. 1;

FIG. 14 shows the 3D depth image spectrum color distribution of the stepped object using the chromatic confocal system of FIG. 1;

FIG. 15 shows the 3D depth image intensity distribution of the stepped object using the chromatic confocal system of FIG. 1;

FIG. 16 illustrates line scanning a trough object using the chromatic confocal system of FIG. 1;

FIG. 17 shows the 2D image spectrum color distribution of the trough object using the chromatic confocal system of FIG. 1;

FIG. 18 shows the 2D image intensity distribution of the trough object using the chromatic confocal system of FIG. 1;

FIG. 19 shows the 3D depth image spectrum color distribution of the trough object using the chromatic confocal system of FIG. 1;

FIG. 20 shows the 3D depth image intensity distribution of the trough object using the chromatic confocal system of FIG. 1;

FIG. 21 is a side sectional view of a 3D chromatic confocal system for line-scanning an object in accordance with another embodiment of the invention;

FIG. 22 provides a side sectional view and an exploded view of a light source for the 3D chromatic confocal system of FIG. 21;

FIG. 23 provides an isotropic view and an exploded view of a slit adjustment mechanism for the 3D chromatic confocal system of FIG. 21;

FIG. 24 provides side sectional views of two alternative 3D imaging modules for the 3D chromatic confocal system of FIG. 21;

FIG. 25 shows light intensities with respect to depth, width-wise profile, and light colors with respect to depth of the line-scanning light beam of a chromatic confocal lens module for the 3D chromatic confocal system of FIG. 21;

FIG. 26 shows light colors and light intensities at different line scanning depths detected by the imaging module of the the 3D chromatic confocal system of FIG. 21;

FIG. 27 illustrates line scanning a trough object using the 3D chromatic confocal system of FIG. 21;

FIG. 28 shows the 3D image spectrum color distribution and the 3D image intensity distribution of the trough object using the 3D chromatic confocal system of FIG. 21;

FIG. 29 illustrates line scanning a stepped object using the 3D chromatic confocal system of FIG. 21;

FIG. 30 shows the 3D image spectrum color distribution and the 3D image intensity distribution of the stepped object using the 3D chromatic confocal system of FIG. 21;

FIG. 31 is a flow diagram of a method or algorithm for line scanning an object using a chromatic confocal system in accordance with the invention;

FIG. 32 is a flow diagram of a calibration method or algorithm for a chromatic confocal system in accordance with the invention; and

FIG. 33 illustrates a calibration setup for a chromatic confocal system in accordance with the invention.

### DESCRIPTION OF PREFERRED EMBODIMENTS

The following description is of preferred embodiments by way of example only and without limitation to the combination of features necessary for carrying the invention into effect.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments, but not other embodiments.

It should be understood that the elements shown in the drawings may be implemented in various forms of hardware, software, or combinations thereof. These elements may be implemented in a combination of hardware and software on one or more appropriately programmed general-purpose devices, which may include a processor, memory, and input/output interfaces.

The present description illustrates the principles of the present invention. It will thus be appreciated that those skilled in the art will be able to devise various arrangements that, although not explicitly described or shown herein, embody the principles of the invention and are included within its spirit and scope.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of systems and devices embodying the principles of the invention.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

In the claims hereof, any element expressed as a means for performing a specified function is intended to encompass any way of performing that function including, for example, a) a combination of circuit elements that performs that function or b) software in any form, including, therefore, firmware, microcode, or the like, combined with appropriate circuitry for executing that software to perform the function. The invention as defined by such claims resides in the fact that the functionalities provided by the various recited means are combined and brought together in the manner which the claims call for. It is thus regarded that any means that can provide those functionalities are equivalent to those shown herein.

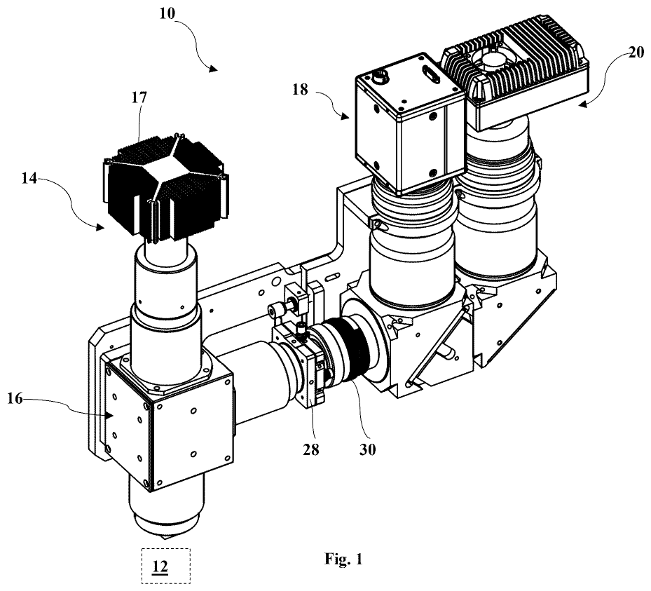

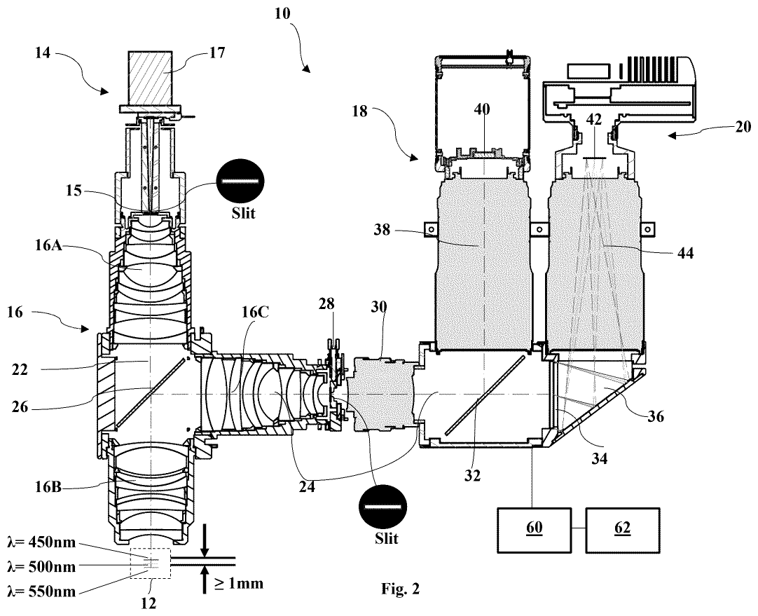

Referring to the drawings, FIG. 1 provides an isotropic view and FIG. 2 provides a side-sectional view of an embodiment of a chromatic confocal system 10 for line-scanning an object 12 in accordance with the invention. The chromatic confocal system 10 comprises a light module 14, a chromatic confocal lens module 16 coaxial with the light module 14, and one or more imaging modules 18, 20. The chromatic confocal system 10 may be used to make 2D and 3D inspections of transparent materials, lens modules, electronic devices or components, computer chip wafers, light reflecting objects, or the like.

The light module 14 is configured to provide a line-scanning light beam which passes along a first light pathway 22 defined by the chromatic confocal lens module 16 to impinge on a surface of the object 12 being line-scanned. The line-scanning light beam preferably exits the light module 14 via a first slit device 15 and enters the first light pathway 22. A slit of the slit device 15 is preferably arranged horizontally with respect to the line-scanning light beam. The light module 14 may include a heatsink 17 for cooling the light module 14.

Line-scanned light reflected from the surface of the object 12 passes back along a lower section of the first light pathway 22 before being diverted into a second light pathway 24 towards the one or more imaging modules 18, 20. The chromatic confocal lens module 16 preferably comprises sets of lenses 16A, B, C for directing and focusing the line-scanning light beam along the first light pathway 22 and for directing and focusing the line-scanned light reflected from the surface of the object 12 back along the lower section of the first light pathway 22 and then along the second light pathway 24. The sets of lenses 16A, B, C may comprise any suitable combination of: collimating lenses; chromatic lenses; and focusing lenses. Preferably, the chromatic confocal lens module 16 has a magnification ratio of 1:1 from the first slit device 15 to the object 12. The field of view (FOV) of the chromatic confocal lens module 16 is ≥5 mm. The chromatic confocal lens module preferably comprises at least four pairs of lenses in the set of lenses 16B to produce a required amount of chromatic aberration.

The light module 14 is configured such that it provides a line-scanning light beam which has a predefined, limited range of wavelengths within the visible light spectrum. Preferably, the predefined, limited range of wavelengths falls within a lower half of the visible light spectrum. Preferably also, the predefined, limited range of wavelengths comprises 40% or less of the light wavelengths comprising the visible light spectrum. In this context, the visible light spectrum is considered as comprising light wavelengths in the range of 380 nanometers (nm) to 750 nm. Preferably, the predefined, limited range of wavelengths comprise the blue and green light wavelengths within the visible light spectrum. In this embodiment, the predefined, limited range of wavelengths comprises wavelengths in a range of 400 nm to 550 nm, and preferably 450 nm to 550 nm.

The arrangement of the light module 14 and the chromatic confocal lens module 16 is such that a numerical aperture (NA) of the first light pathway 22 of the chromatic confocal lens module 16 results in the line-scanning light beam having a spot size diffraction (Abbe) limitation or focusing spot size of about 0.5 μm, preferably ≤0.5 μm.

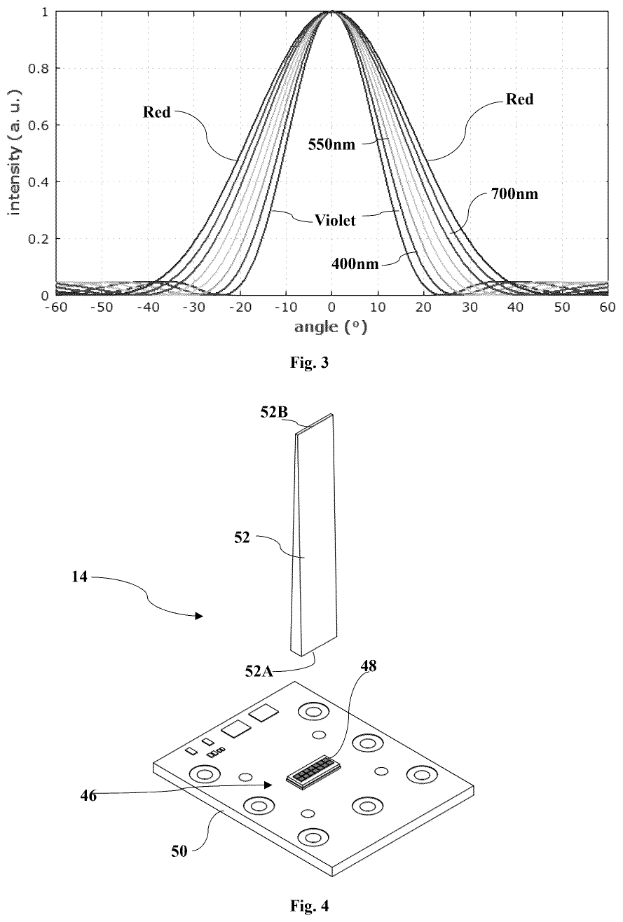

Reference is made to FIG. 3 which provides a graph showing intensity of different light wavelengths to their respective diffraction angles with the larger diffraction angles corresponding to the red and larger sized wavelengths and the smaller diffraction angles corresponding to the violet and smaller sized wavelengths. It will be understood that blue-green light has a smaller Airy disk than red-orange light and consequently blue-green light makes it possible to achieve higher image resolutions than light having larger wavelengths. Blue-green light can enable image resolutions of ≤0.5 μm to be achieved by the line-scanning light beam. This is resolution in image depth, i.e., resolution in the X/Z axis of the chromatic confocal system 10 where the X-axis aligns with the width of the line-scanning light beam, the Y-axis is aligned with the direction of scanning by the line-scanning light beam, and the Z-axis defines the depth of the imaged surface of the object 12.

In this embodiment of the chromatic confocal system 10, the spot size diffraction limitation (Abbe limitation) is given by:

$$d = \frac{λ}{2 NA} ∼ 0.5 μm$$

where d is the diameter of the spot size;
λ is the wavelength of light; and
NA is the numerical aperture of the chromatic confocal lens module 16.

In this embodiment of the chromatic confocal system 10, the spectral depth span of the line-scanning light beam is ≥1 mm for light wavelengths in the range of 450 nm to 550 nm.

The one or more imaging modules 18, 20 may comprise a first imaging module comprising a 2D imaging module 18 and a second imaging module comprising a 3D imaging module 20. The 2D and 3D imaging modules 18, 20 are preferably arranged so as to receive line-scanned light reflected from the surface of the object 12 from the second light pathway 24.

Each of the 2D and 3D imaging modules 18, 20 has respective means to extract line-scanned light reflected from the surface of the object 12 from the second light pathway 24.

A first beam splitter plate 26 is provided in the chromatic confocal lens module 16 to divert the line-scanned light reflected from the surface of the object 12, which initially passes back up the lower section of the first light pathway 22, into the second light pathway 24. The line-scanned light reflected from the surface of the object 12 passes along the second light pathway 24 to exit the chromatic confocal lens module 16 preferably via a second slit device 28. The second slit device 28 preferably has a horizontally arranged slit. The second slit device 28 may comprise a slit alignment or slit adjustment mechanism as will be described hereinafter. Line-scanned light reflected from the surface of the object 12 exiting from the second slit device 28 then preferably passes through a collimating lens module 30. The collimating lens module 30 preferably has a 25 mm focal length.

The collimated light emerging from the collimating lens module 30 then passes further along the second light pathway 24 where it meets a second beam splitter plate 32 which diverts collimated light from the second light pathway 24 into one of the imaging modules 18, 20; in this case, into the 2D imaging module 18. The second beam splitter plate 32 comprises the means for extracting light from the second light pathway 24 into the 2D imaging module 18. The 2D imaging module 18 preferably has a condenser lens module 38 for focusing the extracted light onto a first image sensor 40 of the 2D imaging module 18. In this embodiment, the first image sensor 40 may comprise a 5K-by-5K 2D image sensor comprising about 5000 pixels by 5000 pixels resulting in resolution similar to 4K or 1080p. The focal length of the condenser lens module 38 may be 100 mm.

Collimating light passing yet further along the second light pathway 24 is then diverted into the 3D imaging module 20 by a combination of a diffraction grating 34 and a prism or mirror 36. The diffraction grating 34 is arranged such that a plane of the diffraction grating 34 is normal to the second light pathway 24. In this embodiment, the diffraction grating 34 preferably has a groove or line density of between 600 grooves or lines per mm (600 pl/mm) and 830 μl/mm.

The prism or mirror 36 follows the diffraction grating 34. The prism or mirror 36 is arranged such that its light reflecting surface is preferably placed at an angle of between 30 degrees to 40 degrees with respect to an axis of the second light pathway 24, i.e., with respect to a direction of collimated light travelling along the second light pathway 24. This angle range is selected as it beneficially places the 500 nm wavelength of light reflected from the object 12 near to a center of the 3D imaging module 20 and, more particularly, near to a center of a second image sensor 42 of the 3D imaging module 20. More specifically, it is preferred that the light reflecting surface is placed at an angle of 37.08 degrees with respect to the axis of the second light pathway 24 to place the 500 nm wavelength of light reflected from the object 12 at the center of the second image sensor 42 of the 3D imaging module 20.

The 3D imaging module 20 also preferably has a condenser lens module 44 for focusing the extracted light onto the second image sensor 42 of the 3D imaging module 20. Again, in this embodiment, the focal length of the condenser lens module 44 may be 100 mm. It is preferred that the focal length of the condenser lens module 38 of the 2D imaging module 18 is always the same as the focal length of the condenser lens module 44 of the 3D imaging module 20. The condenser lens module 38 of the 2D imaging module 18 and the condenser lens module 44 of the 3D imaging module 20 preferably each have the same magnification ratios. These may comprise any of 4:1, 2:1, or 1:1. The second image sensor 42 may comprise a 5K-by-5K 3D image sensor to provide the same image resolution as the first image sensor 40.

The arrangement of the 2D imaging module 18 and the 3D imaging module 20 in the chromatic confocal system 10 is such that the two imaging modules 18, 20 can simultaneously generate images from the same line-scanned light reflected from the surface of the object 12.

FIG. 4 provides an exploded view of main components of the light module 14. The light module 14 comprises a light source 46 preferably comprising one or more rows of light emitting diode (LED) chips 48 comprising an array of closely positioned LED chips 48. The LED chips 48 emit light in the blue-green light range of the visible light spectrum and preferably in the range of 400 nm to 550 nm. The LED chips 48 may be arranged on a circuit board 50 to comprise a chip-on-board (COB) circuit board 50. The light module 14 includes a light guide rod 52. The light guide rod 52 extends between the LED chips 48 and the slit of the slit device 15 (FIG. 2). The light guide rod 52 guides light emitted by the one or more rows of LED chips 48 to the slit of the slit device 15 to inject said light into the first light pathway 22.

The light guide rod 52 preferably comprises a wedge-shaped rod or element with a substantially rectangular cross-section. The rod 52 has a light incident end 52A for receiving light from the LED chips 48 and a light emitting end 52B for transmitting light through the slit of the slit device 15 to the first light pathway 22. The light incident end 52A is larger than the light emitting end 52B. The light incident end 52A is preferably of a size which closely or exactly matches a light emitting footprint of the one or more rows of LED chips 48. The light emitting end 52B is preferably of a size which closely or exactly matches the size of the slit of the slit device 15.

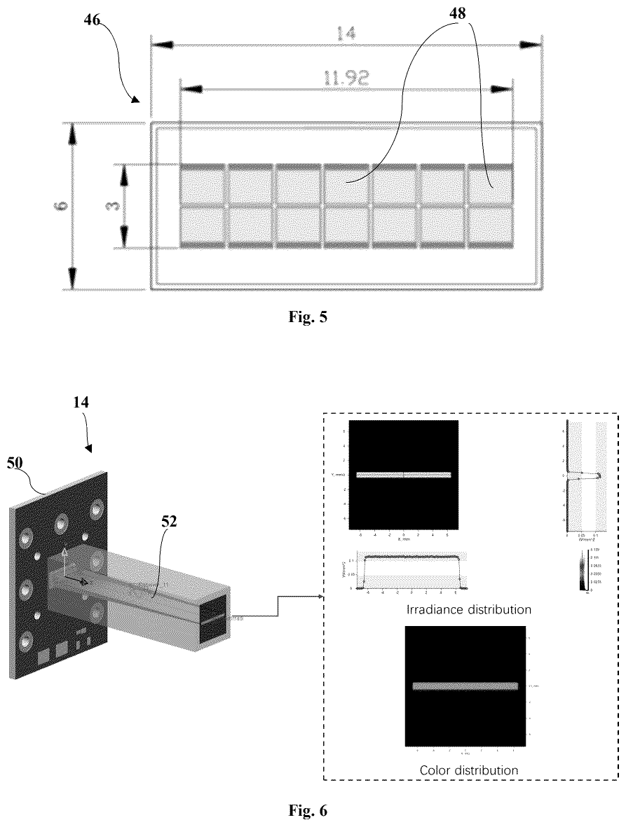

FIG. 5 provides a plan view of the array of LED chips 48 (not to scale) with possible dimensions shown in mm although it will be understood that the dimensions shown are not essential dimensions of the array.

FIG. 6 provides an optical simulation result of the light module 14. The image of the light module 14 on the left of FIG. 6 shows the simulation of ray tracing. The upper image on the right of FIG. 6 comprises the distribution of light intensity (or so called radiance), and the lower image on the right of FIG. 6 comprises the distribution of blue and green colors at the light emitting end 52B of the light guide rod 52. It has been found that the uniformity can exceed 99%.

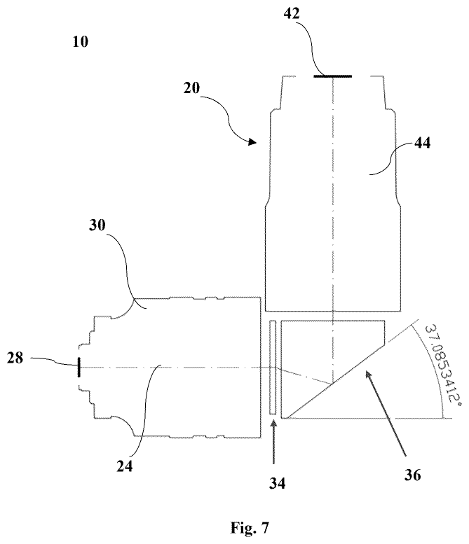

FIG. 7 is a schematic sectional view of a 3D imaging module for the chromatic confocal system 10 of FIGS. 1 and 2. Like numerals are used to denote like parts. In this embodiment of the chromatic confocal system 10 there is no 2D imaging module, only a 3D imaging module.

It will be understood that the chromatic confocal system 10 can comprise: an embodiment with both the 2D imaging module 18 and 3D imaging module 20 as shown in FIGS. 1 and 2; an embodiment with only the 2D imaging module 18; and an embodiment with only the 3D imaging module 20 as shown in FIG. 7.

FIG. 7 also usefully illustrates the preferred angle of the reflecting surface of the prism or mirror 36 with respect to the direction of travel of the image reflected light travelling along the second light pathway 24, i.e., with respect to the axis of the second light pathway 24.

As already explained, the preferred angle of 37.08 degrees or the preferred range of 30 degrees to 40 degrees angles are selected so as to place the 500 nm wavelength of light reflected from the object 12 at or near to the center of the second image sensor 42 of the 3D imaging module 20. This is also the case for the first image sensor 40 of the 2D imaging module 18 of the embodiment of FIGS. 1 and 2. Furthermore, the preferred angle of 37.08 degrees or the preferred range of 30 degrees to 40 degrees angles is selected so as to place the 450 nm wavelength and the 550 nm wavelength of light reflected from the object 12 near to respective edges of the first image sensor 40 of the 2D imaging module 18 and near to the edges of the second image sensor 42 of the 3D imaging module 20. This has the advantage that wavelengths of image reflected light residing outside the 450 nm to 550 nm range are substantially blocked from respectively reaching the first image sensor 40 or the second image sensor 42 by respective housings of the first imaging module 18 and the second imaging module 20.

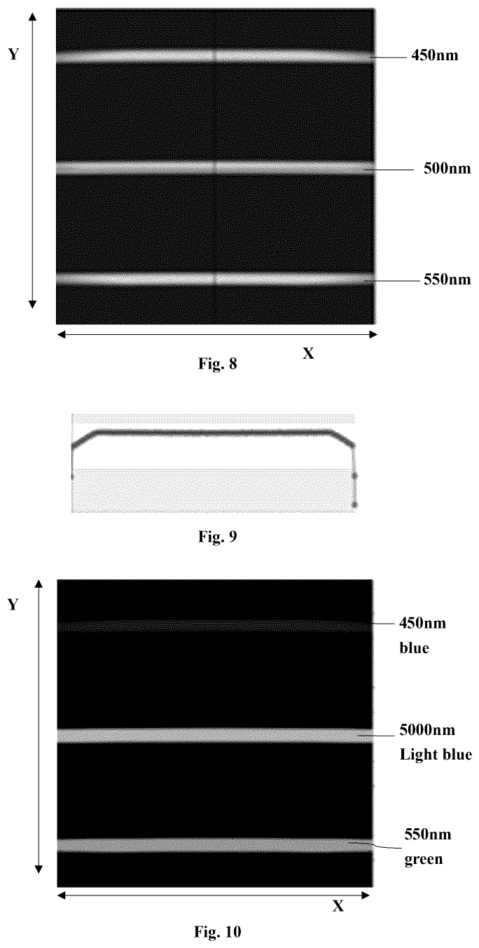

FIG. 8 shows in grey scale the light intensities detected at different depths (Z) over the line-scanning width (X) and along the line-scanning length (Y) by the image sensor 42 of the imaging module of FIG. 7, namely at depths corresponding respectively to 450 nm, 500 nm, and 550 nm.

FIG. 9 shows the width-wise (X) profile of each of the light intensities detected at different depths (Z) by the image sensor 42.

FIG. 10 shows (in grey scale) the light colours detected at different depths (Z) over the line-scanning width (X) and along the line-scanning length (Y) by the image sensor 42.

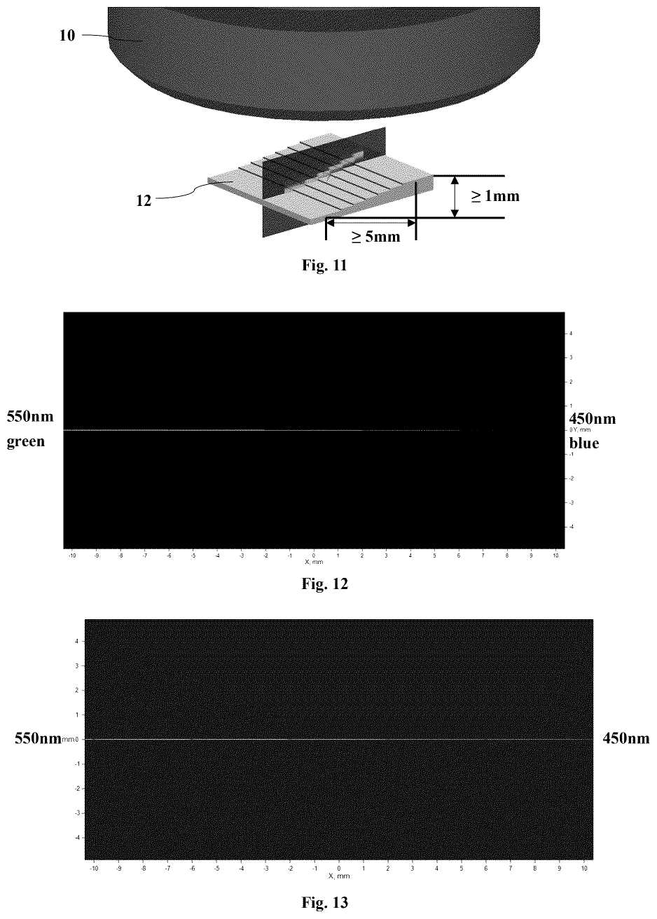

FIG. 11 illustrates line-scanning a stepped object 12 using the chromatic confocal system 10 of FIGS. 1 and 2 to enable simultaneous image generation by the 2D imaging module 18 and the 3D imaging module 20.

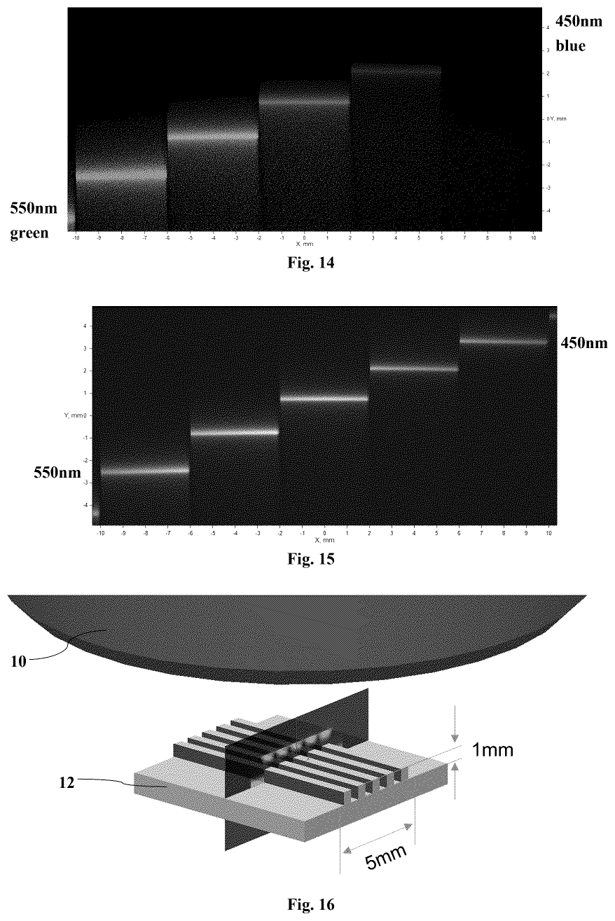

FIG. 12 shows in grey scale the 2D image spectrum color distribution of the stepped object 12 whilst FIG. 13 shows the 2D image intensity distribution of the stepped object 12. FIG. 14 shows in grey scale the 3D depth image spectrum color distribution of the stepped object 12 whilst FIG. 15 shows the 3D depth image intensity distribution of the stepped object 12.

FIG. 16 illustrates line scanning a trough object 12 using the chromatic confocal system 10 of FIGS. 1 and 2 to enable simultaneous image generation by the 2D imaging module 18 and the 3D imaging module 20.

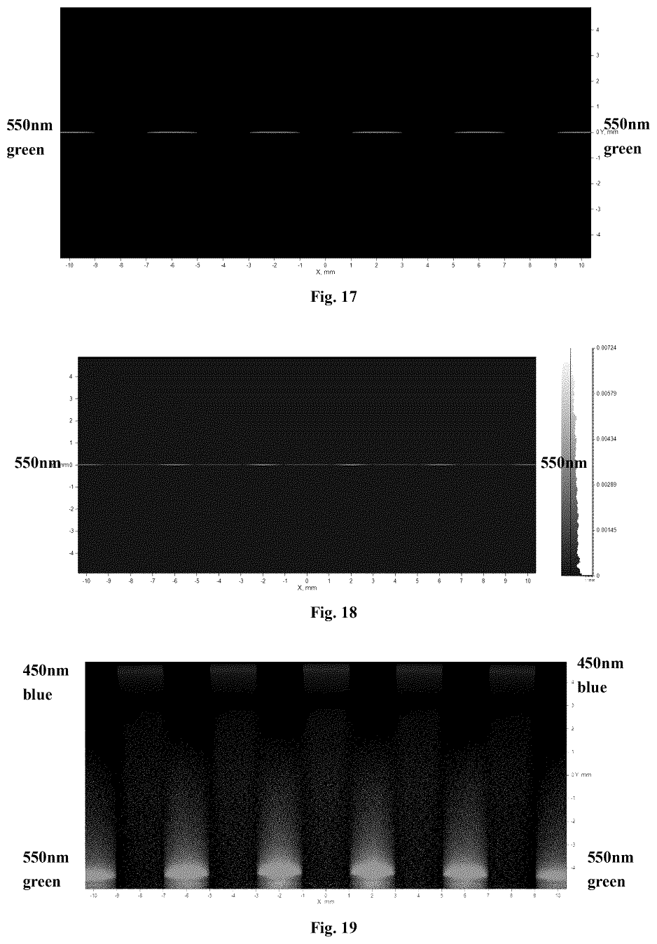

FIG. 17 shows in grey scale the 2D image spectrum color distribution of the trough object 12 whilst FIG. 18 shows the 2D image intensity distribution of the trough object 12. FIG. 19 shows in grey scale the 3D depth image spectrum color distribution of the trough object 12 whilst FIG. 20 shows the 3D depth image intensity distribution of the trough object 12.

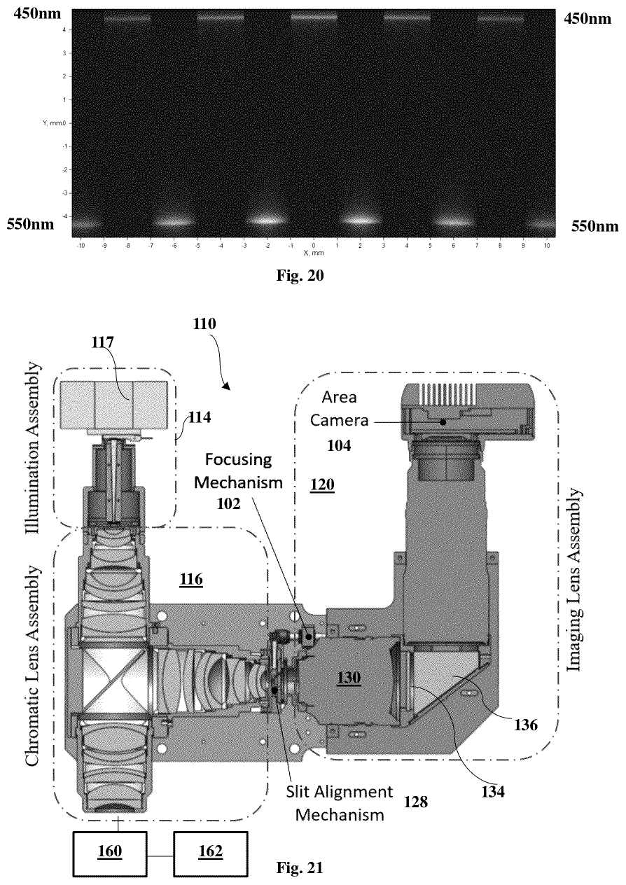

FIG. 21 is a side sectional view of a 3D chromatic confocal system 110 for line-scanning an object in accordance with another embodiment of the invention. Like numerals to those used in connection with the embodiment of FIGS. 1 and 2 are employed but preceded by the numeral “1”. This embodiment is intended for only 3D imaging.

The chromatic confocal system 110 comprises an illumination assembly or light module 114, a chromatic lens assembly or a confocal lens module 116 arranged coaxially with the light module 114, a slit alignment mechanism 128 at a light output of the confocal lens module 116, a focusing mechanism 102 associated with the slit alignment mechanism 128, and an imaging lens assembly or 3D imaging module 120. Included is a collimating lens module 130 which forms part of the 3D imaging module 120. A 3D image sensor (not shown) is provided by a 3D camera 104. The operation of the chromatic confocal system 110 is generally the same as that described for the chromatic confocal system 10 of FIGS. 1 and 2 but not including 2D imaging.

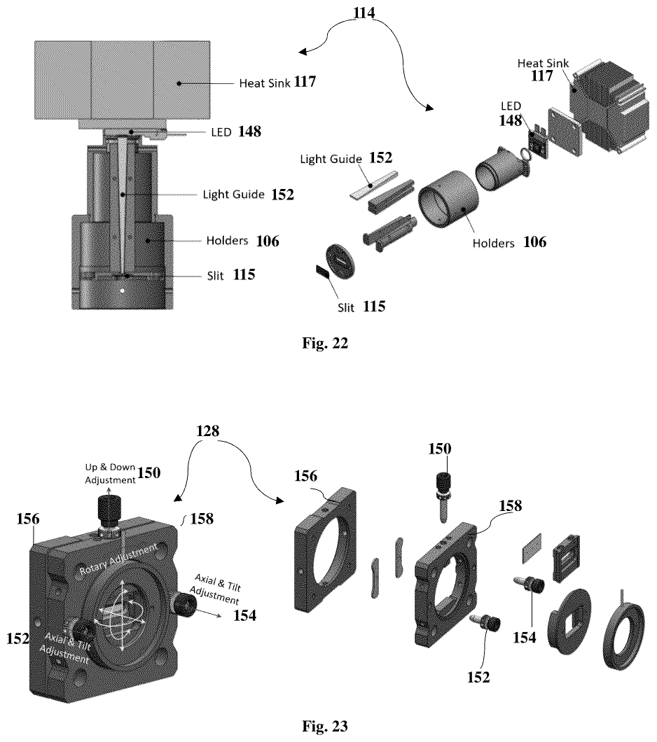

FIG. 22 provides a side sectional view and an exploded view of the light module 114 for the 3D chromatic confocal system 110. The light module includes a heatsink 117 for cooling the COB LED chips 148. A wedge-shaped light guide rod 152 extends between the COB LED chips 148 and a slit device 115. A number of holders 106 are provided to position the light guide rod 152 within the the light module 114.

FIG. 23 provides an isotropic view and an exploded view of a slit alignment or adjustment mechanism 128 for the 3D chromatic confocal system 110. The slit adjustment mechanism 128 is preferably provided with 5 axis to enable adjustment of the slit positioned at the light exit or output of the confocal lens module 116. The slit adjustment mechanism 128 comprises an up/down axial adjuster 150, a first axial and tilt adjuster 152 and a second axial and tilt adjuster 154. First and second plates 156, 158 comprising a housing of the slit adjustment mechanism 128 enable the 3D imaging module 120 to be mounted to the confocal lens module 116.

The slit adjustable mechanism 128 is preferably a multi-axis device being linearly adjustable in each of the Y and Z axis, rotatably adjustable around an axis of the second light pathway 24, and angularly adjustable with respect to the axis of the second light pathway 24.

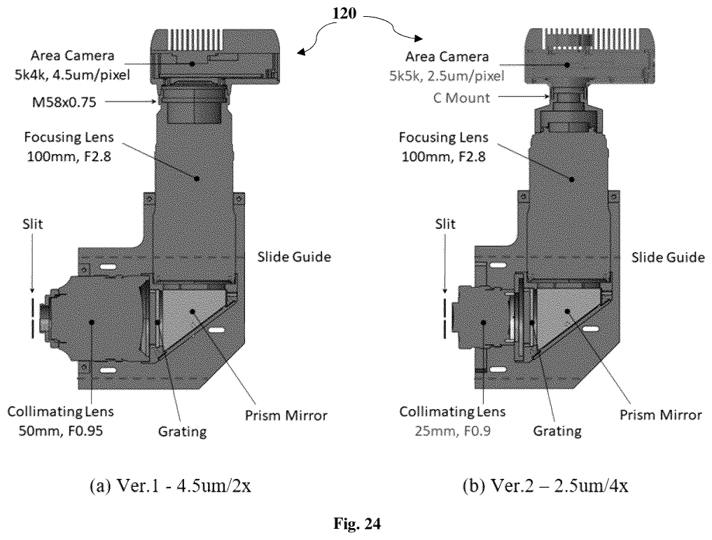

FIG. 24 provides side sectional views of two alternative 3D imaging modules 120 for the 3D chromatic confocal system of FIG. 21.

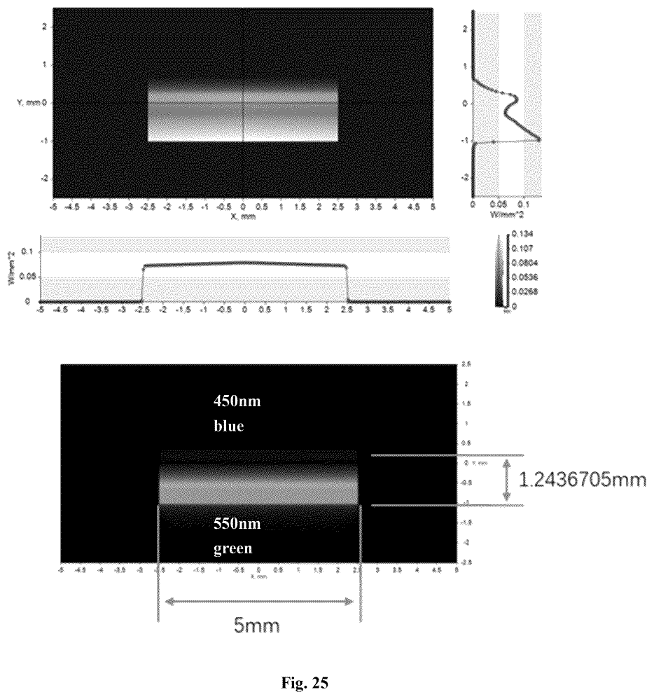

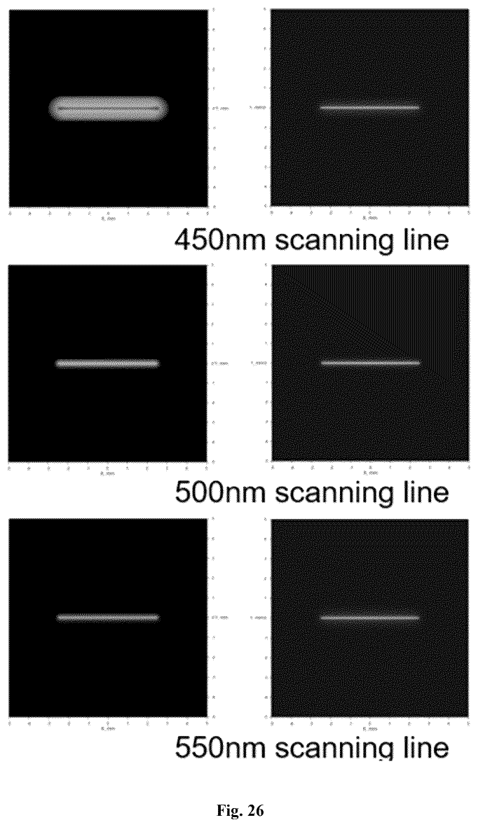

FIG. 25 shows light intensities with respect to depth, width wise profile, and light colors in grey scale with respect to depth of the line-scanning light beam of the 3D chromatic confocal lens module 110 of FIG. 21. FIG. 26 shows light colors in grey scale (left) and light intensities (right) at different line scanning depths detected by the imaging module 120 of the the 3D chromatic confocal system 110 of FIG. 21.

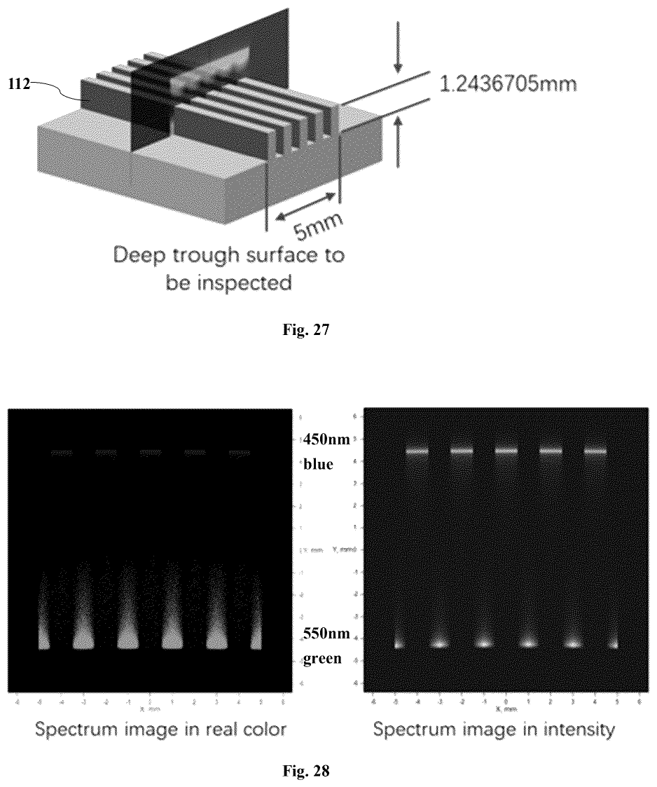

FIG. 27 illustrates line scanning a trough object 112 using the 3D chromatic confocal system 110 of FIG. 21. FIG. 28 shows the 3D image spectrum color distribution and the 3D image intensity distribution of the trough object 112.

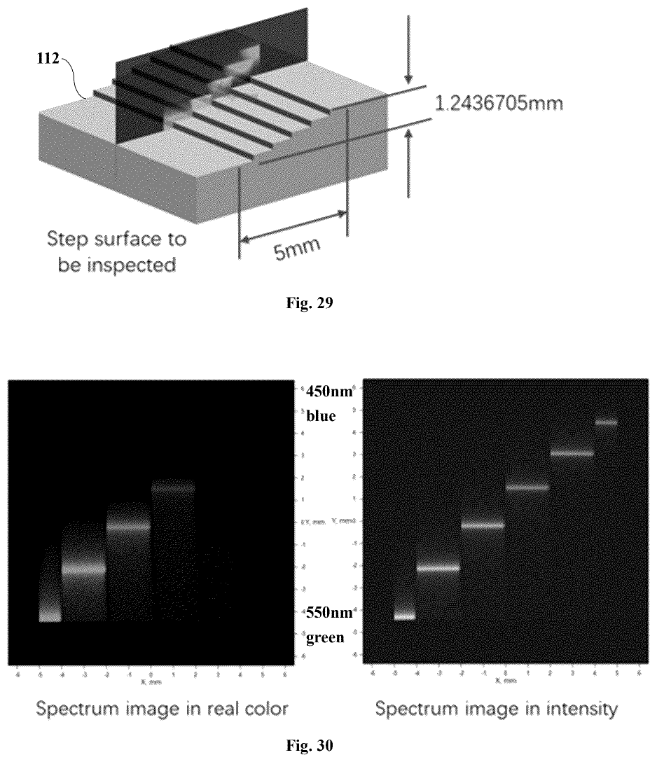

FIG. 29 illustrates line scanning a stepped object 112 using the 3D chromatic confocal system 110 of FIG. 21. FIG. 30 shows the 3D image spectrum color distribution and the 3D image intensity distribution of the stepped object 112.

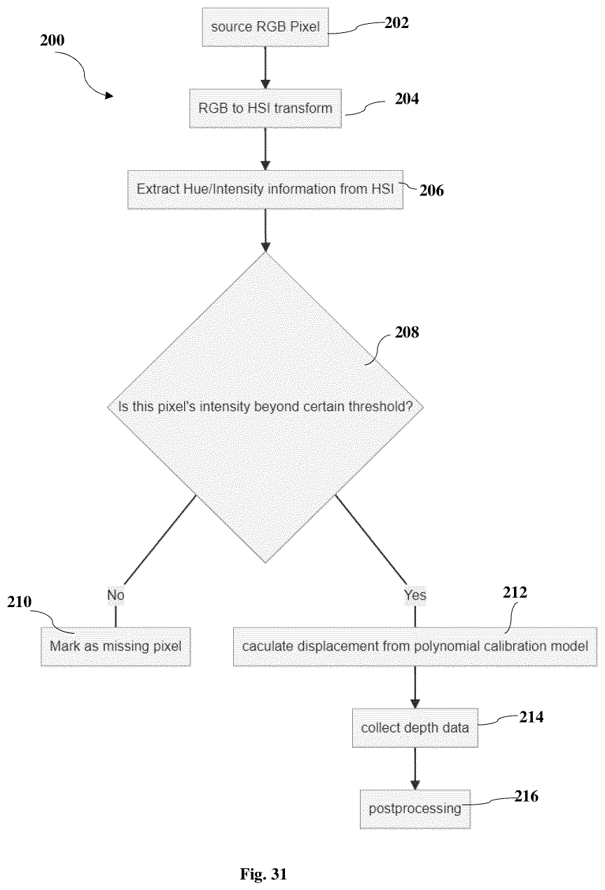

FIG. 31 is a flow diagram of a method 200 or algorithm for line scanning an object 12, 112 using a chromatic confocal system 10, 110 in accordance with the invention.

The method 200 may be implemented by a processor 60 (FIG. 2) or 160 (FIG. 21) associated with the chromatic confocal system 10, 110 executing machine-readable instructions stored on a non-transitory computer-readable medium 62 such as a memory 62 (FIG. 2) or 162 (FIG. 21), the machine-readable instructions causing the processor 60, 160 to implement the methods described herein.

A color sensitive camera or image sensor can achieve high color accuracy in Red-Green-Blue (RGB) space. 2D and 3D information can be detected in the optical slit by a single-color sensitive line camera. Displacement or depth of a translucent surface can be detected as a single dominant RGB color. The RGB color represents a specific wavelength which also represents a specific displacement or depth gamut and is a one-to-one relationship.

The method 200 configures the processor 60, 160 to generate a 2D or 3D image from image data received from the image sensor 40, 42 of the chromatic confocal system 10, 110.

The method 200 enables 2D and 3D sensing using a line-scan camera or image sensor instead of an area scan camera or image sensor with a possible speed up to 18K foot-per-second (fps). The method 200 comprises a single algorithm which calculates the displacement or depth information and grey scale information of the surface of the line-scanned object instead of requiring two separate algorithms as in conventional chromatic confocal systems hence increasing the processing speed for image generation of the scanned object. The method also enables micron-level displacement resolution accuracy.

Whilst the method 200 is intended for use with the chromatic confocal system 10, 110 using blue-green light, the method 200 can be employed with white light and so is not limited to any defined range within the visible light spectrum.

The method comprises a first step 202 of receiving RGB image or pixel data from the image sensor 40, 42. A next step 204 comprises transforming the RGB image data to Hue-Saturation-Intensity (HSI) values. Color can be transformed from the RGB color space to HSI values. Hue (H) is monotonic and a H value can be mapped to a specific wavelength. Hue is a color attribute which is invariant of surface roughness and lighting reflection characteristics. The RGB color space, once normalized to the range [0, 1], can be transformed to HSI values using the following equations:

Steps to be followed:

$$Read a RGB image . \qquad 1$$

$$Represent the RGB image in the range [ 01 ] . \qquad 2$$

$$Find HSI components . \qquad 3$$

$$θ = {cos}^{- 1} \{ \frac{\frac{1}{2} [ ( R - G ) + ( R - B ) ]}{[ {( R - G )}^{2} + ( R - B ) {( G - B )}^{1 / 2} ]} \}$$

$$H ( Hue ) = \{ \begin{matrix}θ & If B <= G \\ 360 - θ & If B > G\end{matrix} . \qquad 4$$

$$S ( Saturation ) = 1 - \frac{3}{( R + G + B )} [ min ( R , G , B ) ] . \qquad 5$$

$$I ( Intensity ) = \frac{1}{3} ( R + G + B ) . \qquad 6$$

In a next step 206, the method 200 comprises extracting or separating the separating the H values from the HSI values.

In a next but optional step 208, the method 200 comprises comparing the I or S values corresponding to the extracted or separated H values to a predetermined or calculated threshold and optionally discarding any H values not meeting the threshold as missing pixels in step 210. The threshold may be determined or calculated from the corresponding I values and S values.

In a next step 212, the method 200 comprises using the extracted or separated H values to determine hue-to-displacement (depth) relationship values based on a plane mirror or plane gauge calibration model of the chromatic confocal system 10, 100. Preferably, the calibration model comprises a polynomial function derived from a best polynomial fit of the H values obtained from the plane mirror or plane gauge calibration procedure.

In a next step 214, the method 200 collects the depth data and in a final step 216 post-processes the depth data to generate 2D or 3D images of the scanned object 12, 112.

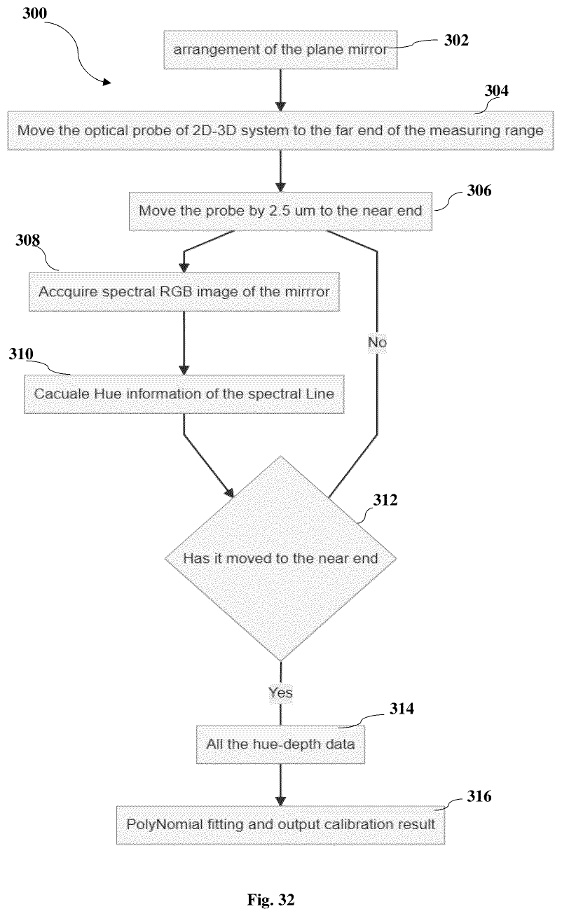

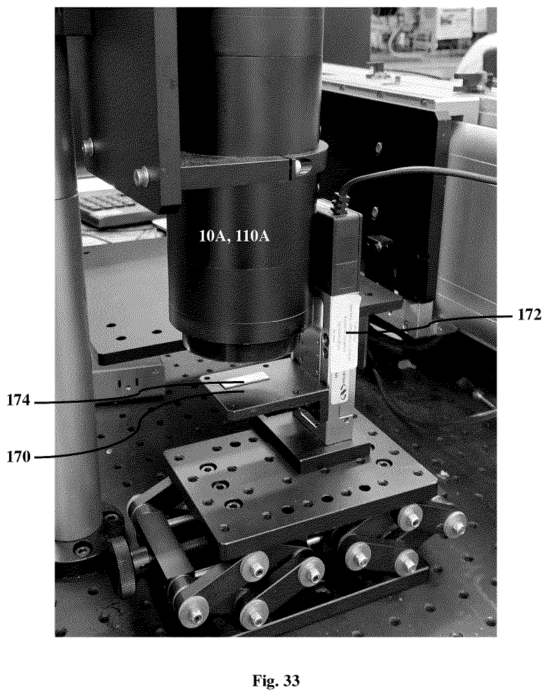

FIG. 32 is a flow diagram of a calibration method 300 or algorithm for the chromatic confocal system 10, 100. The method 300 may be implemented using a high-precision linear Z-axis motor and a plane mirror or plane gauge as a reference flat surface. The method 300 involves calculating the flat surface profile's hue information to generate contour lines of the flat surface.

The method 300 includes moving the Z-axis from low to high positions in linear steps throughout the measurement range. In addition to calculating the reference flat surface profile's hue information, it includes recording the hue information in each height position and recording the height positions from the Z-axis motor readings. The method 300 involves using a polynomial fitting model to model the hue-displacement relationship of the reference flat surface. The resulting regression polynomial model is saved for hue-displacement calibration.

The method 300 comprises a first step 302 arranging a plane mirror or plane gauge for line-scanning by the chromatic confocal system 10, 100. In a second step 304, the method 300 comprises moving the optical probe of the chromatic confocal system 10, 100 to a far end of the measuring range of the chromatic confocal system 10, 100. In a next step 306, the optical probe is moved in set distance increments to a near end of the measuring range of the chromatic confocal system 10, 100. The set distance increments could be set as 2.5 μm. In a next step 308, line spectral RGB image for the current set distance of the plane mirror or plane gauge reference flat surface is obtained. In a further step 310, hue information of the acquired line spectral RGB image for the current set distance is calculated. The method may include step 312 where, if it is determined that the optical probe has already been moved to the near end of the measuring range, the method does not repeat steps 308 and 310 for any further set incremental distances. Once all hue information for all acquired line spectral RGB images has been calculated in step 314, the method concludes in step 316 with using the polynomial fitting model to model the hue-displacement relationship of the reference flat surface and outputting the calibration result.

FIG. 33 illustrates a calibration setup for the chromatic confocal system 10, 110 in which the optical probe 10A, 110A of the chromatic confocal system 10, 110 is arranged on a plate 170 of the Z-axis motor 172 above the plane mirror or plane gauge 174.

The invention also provides a non-transitory computer-readable medium storing machine-readable instructions, wherein, when the machine-readable instructions are executed by a processor, they configure the processor to implement the method of any one of the appended method claims.

The apparatus described above may be implemented at least in part in software. Those skilled in the art will appreciate that the apparatus described above may be implemented at least in part using general purpose computer equipment or using bespoke equipment.

Here, aspects of the methods and apparatuses described herein can be executed on any apparatus comprising the communication system. Program aspects of the technology can be thought of as “products” or “articles of manufacture” typically in the form of executable code and/or associated data that is carried on or embodied in a type of machine-readable medium. “Storage” type media include any or all of the memory of the mobile stations, computers, processors or the like, or associated modules thereof, such as various semiconductor memories, tape drives, disk drives, and the like, which may provide storage at any time for the software programming. All or portions of the software may at times be communicated through the Internet or various other telecommunications networks. Such communications, for example, may enable loading of the software from one computer or processor into another computer or processor. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible non-transitory “storage” media, terms such as computer or machine “readable medium” refer to any medium that participates in providing instructions to a processor for execution.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

In the claims which follow and in the preceding description of the invention, except where the context requires otherwise due to express language or necessary implication, the word “comprise” or variations such as “comprises” or “comprising” is used in an inclusive sense, i.e., to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art.

1. A chromatic confocal system for line-scanning an object, the system comprising:
a light module for providing a line-scanning light beam;
a chromatic confocal lens module defining a first light pathway for directing the line-scanning light beam along said first light pathway and focusing the line-scanning light beam to impinge on a surface of the object, the lens module defining a second light pathway for directing line-scanned light reflected from the surface of the object to one or more imaging modules;
wherein the line-scanning light beam has a predefined, limited range of wavelengths within the visible light spectrum.

2. The chromatic confocal system of claim 1, wherein the predefined, limited range of wavelengths comprises blue and green light wavelengths within the visible light spectrum.

3. The chromatic confocal system of claim 1, wherein the predefined, limited range of wavelengths comprises wavelengths in a range of 400 nm to 550 nm, preferably 450 nm to 550 nm.

4. The chromatic confocal system of claim 1, wherein a numerical aperture of the first light pathway of the chromatic confocal lens module is configured such that the line-scanning light beam has a spot size diffraction limitation of about 0.5 μm.

5. The chromatic confocal system of claim 1, wherein a magnification ratio of the first light pathway of the chromatic confocal lens module is configured to be 1:1.

6. The chromatic confocal system of claim 1, wherein the one or more imaging modules comprise a first imaging module and a second imaging module, the first and second imaging modules being arranged so as to receive line-scanned light reflected from the surface of the object from the second light pathway.

7. The chromatic confocal system of claim 6, wherein each of the first and second imaging modules has means to extract line-scanned light reflected from the surface of the object from the second light pathway.

8. The chromatic confocal system of claim 7, wherein the first and second imaging modules each has a respective imaging sensor and a respective lens module for focusing the line-scanned light reflected from the surface of the object extracted from the second light pathway to their respective image sensors, wherein the respective lens modules have the same focal length.

9. The chromatic confocal system of claim 7, wherein the first imaging module comprises a 2D imaging module and the second imaging module comprises a 3D imaging module, wherein the 2D imaging module and the 3D imaging module are configured to simultaneously generate images from the line-scanned light reflected from the surface of the object extracted from the second light pathway.

10. The chromatic confocal system of claim 7, wherein the first imaging module has a beam splitter plate for extracting the line-scanned light reflected from the surface of the object from the second light pathway and/or wherein the second imaging module has a diffraction grating and a prism or mirror for extracting the line-scanned light reflected from the surface of the object from the second light pathway.

11. The chromatic confocal system of claim 10, wherein the diffraction grating is arranged such that a plane of the diffraction grating is normal to the second light pathway and wherein the a reflecting surface of the prism or the mirror is arranged at an angle of between 30 degrees to 40 degrees with respect to the second light pathway.

12. The chromatic confocal system of claim 11, wherein the reflecting surface of the prism or the mirror is arranged at an angle of 37.08 degrees with respect to the second light pathway.

13. The chromatic confocal system of claim 1, wherein the light module comprises:
a light source comprising one or more rows of light emitting diode (LED) chips emitting light in the range of 400 nm to 550 nm;
a slit defining a start of the first light pathway; and
a light guide rod extending between the light source and the slit, the light guide rod guiding light emitted by the one or more rows of LED chips to the slit to inject said light into the first light pathway.

14. The chromatic confocal system of claim 13, wherein the light guide rod comprises a wedge-shaped element with a substantially rectangular cross-section, the element having a light incident end of a size which matches a light emitting footprint of the one or more rows of LED chips and a light emitting end of a size which matches the size of the slit, wherein the light emitting end is smaller in size than the light incident end.

15. The chromatic confocal system of claim 1, wherein the second light pathway includes a collimating lens module in advance of the one or more imaging modules and a slit prior to the collimating lens module.

16. The chromatic confocal system of claim 15, wherein the slit comprises a multi-axis adjustable mechanism, being linearly adjustable in each of the Y and Z axis, rotatably adjustable around an axis of the second light pathway, and angularly adjustable with respect to the axis of the second light pathway.

17. A chromatic confocal lens module for a line-scanning system, comprising:
an input for receiving a line-scanning light beam from a light source;
a first light pathway for directing the line-scanning light beam along said first light pathway and focusing the line-scanning light beam to impinge on a surface of an object;
a second light pathway for directing line-scanned light reflected from the surface of the object to an output;
wherein the line-scanning light beam has a predefined, limited range of wavelengths comprising blue and green light wavelengths within the visible light spectrum.

18. A method of generating a 2D or 3D image from image data received from an image sensor of the chromatic confocal system of claim 1, the method comprising:
receiving Red-Green-Blue (RGB) image data from the image sensor;
transforming the RGB image data to Hue-Saturation-Intensity (HSI) values;
separating the H values from the HIS values; and
using the separated H values to determine hue-to-displacement relationship values based on a plane mirror or plane gauge calibration model of the chromatic confocal system.

19. The method of claim 18, further comprising filtering out hue-to-displacement relationship values as false values if the I or S values corresponding to the separated H values do not meet a predetermined or calculated threshold.

20. The method of claim 18, wherein the calibration model comprises a polynomial function derived from a best polynomial fit of the hue values obtained from the plane mirror or plane gauge.
